(19) United States
(12) Patent Application Publication
(10) Pub. No.: US 2002/0197020 A1
(43) Pub. Date: Dec. 26, 2002

(54) Optical fiber collimator with long working distance and low insertion loss

(76) Inventors: Charles Qian, Cupertino, CA (US); Yi Qin, Pleasanton, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 09/888,702

(22) Filed: Jun. 23, 2001

(51) Int. Cl. G02B 6/36; G02B 6/32

(52) U.S. Cl. 385/80; 385/79; 385/33

(57) ABSTRACT

A compact, low loss optical fiber collimator design consists of a lens, a glass wedge, and a single- or multi-fiber pigtail. The introduction of the glass wedge ensures minimum off-axis beam deflection and hence improves device reliability. By properly selecting the focusing lens, low insertion losses and long working distances in both reflection (for a multi-fiber collimator) and transmission are achieved. These collimators are critical to interferometer type devices and other micro-optical devices where uniform phase front and/or long path length are desired.

### BACKGROUND OF THE INVENTION

1. Field of the Invention

The present invention relates generally to optical components and their use in optical communications and more particularly to a low loss, long working distance optical fiber collimator.

2. Background Art

Optical fiber and related devices provide new avenues to transmit light and hence are becoming important in areas of optical communication, remote optical measurement and sensing. In many demanding applications, low loss collimators with long working distance are desired.

A typical prior art collimator (100) is depicted in FIG. 1. The collimator consists of an optical fiber 110, a glass ferrule 120 and a GRIN (gradient index) lens 130. The GRIN lens and fiber containing glass ferrule are bonded to a glass tube 140 with a precise gap to ensure desired optical performance. The glass tube 140 is enclosed in and glued to a metal tube 150 (often gold plated) to ensure proper interface with metallic packages of optical devices. The fiber end of the collimator is often protected with epoxy such as 353ND, manufactured by EPOXY TECHNOLOGIES. The adjacent surfaces of the GRIN lens and the glass ferrule are wedged at a small angle (typically 8 degrees) to substantially reduce back reflection (frequently called “Return Loss”).

With minor modifications of the glass ferrule, a multi-fiber collimator can be made. A typical prior art dual-fiber collimator (200) is illustrated in FIG. 2. The collimator consists of optical fibers 210 and 215, a glass ferrule 220 and a GRIN lens 230. The GRIN lens and fiber containing glass ferrule are bonded to a glass tube 240 with a precise gap to ensure desired optical performance. The glass tube 240 is enclosed in and glued to a metal tube 250 (often gold plated) to ensure proper interface with metallic packages of optical devices. The fiber end of the collimator is often protected with epoxy such as 353ND, manufactured by EPOXY TECHNOLOGIES. The adjacent surfaces of the GRIN lens and the glass ferrule are wedged at a small angle (typically 8 degrees) to substantially reduce back reflection.

The most relevant prior art known to the inventor is disclosed in U.S. Pat. Nos. 5,841,591; 6,148,126 and 6,168,319. Each such patent describes a collimator which is much like those of FIGS. 1 and 2 herein and which is therefore not designed for long working distances or a uniform phase front.

There are several disadvantages associated with these prior art collimators. For instance, the usage of a GRIN lens leads to substantial aberrations and phase front distortions and becomes non-practical for applications involving longer focal lengths. There is therefore a need for an improved fiber collimator for applications involving long working distances.

### SUMMARY OF THE INVENTION

In accordance with the present invention, a design of fiber optic collimator with long working distance and low insertion loss is disclosed. In this new design, the GRIN lens in prior art collimator is replaced by a combination of a glass wedge and a collimating lens. In one preferred embodiment, the collimating lens is an aspheric lens. The collimators made in accordance with the present invention have low insertion loss and long working distance. The invention applies to single, dual and multi-fiber collimators.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a simplified diagram illustrating a conventional prior art single-fiber collimator;

FIG. 2 is a simplified diagram illustrating a conventional prior art dual-fiber collimator;

FIG. 3 is a simplified diagram illustrating a single-fiber collimator based on a first preferred embodiment of the present invention;

FIG. 4 is a schematic diagram illustrating a dual-fiber collimator based on a second preferred embodiment of the present invention; and

FIG. 5 depicts a fundamental building block of collimators in accordance with the present invention.

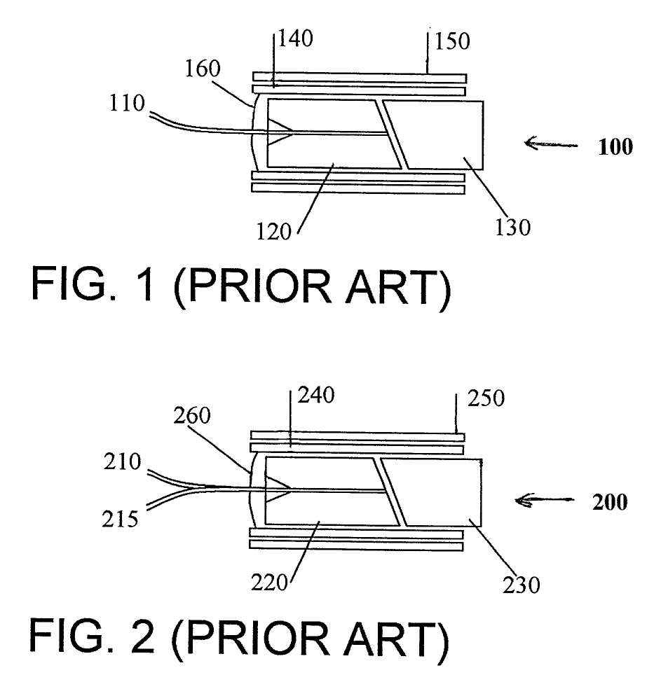

### DESCRIPTION OF THE PREFERRED EMBODIMENTS

In the following the details of various preferred embodiments of the present invention are disclosed. The preferred embodiments are described with the aid of the accompanying drawings, wherein like reference numerals refer to like elements throughout.

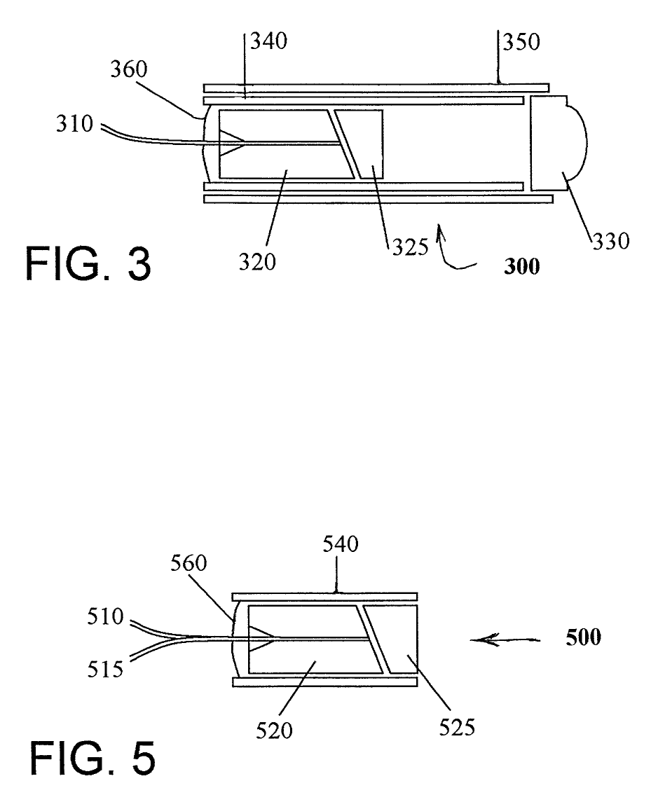

FIG. 3 is a diagram illustrating a single-fiber collimator 300 according to a first embodiment of the present invention. The collimator consists of a single-fiber pigtail, a glass wedge 325 and a collimating lens 330. The fiber pigtail is made with a cylindrical ferrule 320 and an optical fiber 310 inserted in the center of the ferrule. The fiber and ferrule are bonded together with epoxy such as 353ND, manufactured by EPOXY TECHNOLOGIES. The fiber pigtail closely fits inside of a small glass tube 340 and is bonded to tube 340 using epoxy such as 353ND. The surface of the ferrule where optical fiber is terminated is polished to an angle (e.g., eight degrees) in order to reduce the back reflection (Return Loss). A glass wedge 325 with an uniform optical density, is placed immediately in front of the ferrule. The wedged surface of wedge 325 is polished to have a similar angle and the wedge is placed in a way to minimize beam displacement and deflection. A collimating lens 330 is placed at the opposite end of the collimator. Lens 330 is bonded to an outer tubing 350. The distance between the fiber pigtail and the collection lens is adjusted such that a desired performance is obtained. This distance is then fixed by bonding corresponding parts of the collimator. According to one embodiment of the invention, the collimating lens 330 is an aspheric lens. All surfaces of optical components in the collimator are coated with anti-reflective coatings to minimize insertion loss of the collimator. The fiber end of the collimator is protected with epoxy 360 such as 353ND.

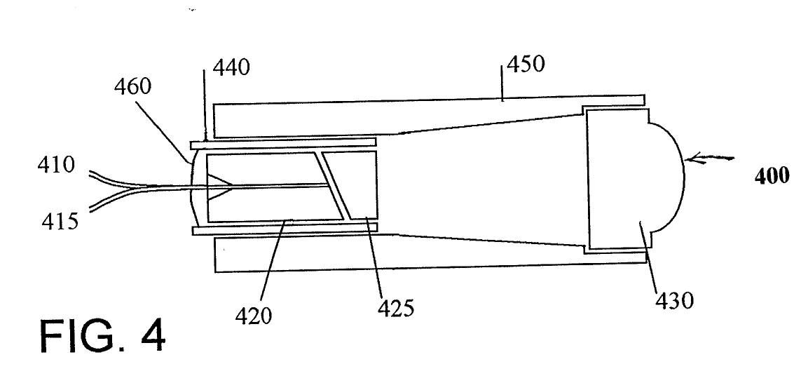

FIG. 4 is a diagram illustrating a dual-fiber collimator 400 according to a second embodiment of the present invention. The collimator consists of a dual-fiber pigtail, a glass wedge 425 and a large collimating lens 430. The fiber pigtail is made with a cylindrical ferrule 420 and two optical fibers 410, 415 inserted near the center of the ferrule. The fibers and ferrule are bonded together with epoxy such as 353ND, manufactured by EPOXY TECHNOLOGIES. The fiber pigtail closely fits inside of a small glass tube 440 and is bonded to tube 440 using epoxy such as 353ND. The surface of the ferrule where optical fibers are terminated is polished to an angle (e.g., eight degrees) in order to reduce back reflection (Return Loss). A glass wedge 425 with a uniform optical density is placed immediately in front of the ferrule. The wedged surface of wedge 425 is polished to have a similar angle and the wedge is placed in a way to minimize beam displacement and deflection. A large collimating lens 430 is placed at the opposite end of the collimator. Lens 430 is bonded to an outer cylindrical package 450. The distance between the fiber pigtail and the collimating lens is adjusted such that a desired performance is obtained. This distance is then fixed by bonding corresponding parts of the collimator. According to one embodiment of the invention, the collimating lens 430 is an aspheric lens. All surfaces of optical components in the collimator are coated with anti-reflective coatings to minimize insertion loss of the collimator. The fiber end of the collimator is protected with epoxy 460 such as 353ND.

FIG. 5 is a diagram illustrating a modified dual-fiber pigtail 500 according to embodiments of the present invention. The fiber pigtail is made with a cylindrical ferrule 520 and two optical fibers 510, 515 inserted near the center of the ferrule. The fibers and ferrule are bonded together with epoxy such as 353ND, manufactured by EPOXY TECHNOLOGIES. The fiber pigtail closely fits inside of a small glass tube 540 and is bonded to tube 540 using epoxy such as 353ND. The surface of the ferrule where optical fibers are terminated is polished to an angle (e.g., eight degrees) in order to reduce back reflection (Return Loss). A glass wedge 525 with a uniform optical density is placed immediately in front of the ferrule. The wedged surface of wedge 525 is polished to have a similar angle and the wedge is placed in a way to minimize beam displacement and deflection. All surfaces of optical components in the modified pigtail are coated with anti-reflective coatings to minimize insertion loss associated with the pigtail. The fiber end of the pigtail is protected with epoxy 460 such as 353ND.

Several optical fiber collimators were assembled in accordance with the present invention. The typical reflection insertion losses of dual-fiber collimators are about 0.25 dB at a working distance of 1 cm. With a pair of randomly selected collimators placed at 41 cm from each other, the observed insertion loss is 0.65 dB.

Having thus disclosed various embodiments of the present invention, it being understood that numerous alternative embodiments are contemplated and that the scope of the invention is limited only by the appended claims and their equivalents, what is claimed is:

1. An optical fiber collimator comprising:
at least one optical fiber having a portion of its length surrounded by a cylindrical glass ferrule bonded to said at least one fiber, the ferrule being enclosed in a glass tube to which the ferrule is bonded along its radial surface, said ferrule terminating at one end in an axial surface that is at a non-perpendicular angle relative to said surrounded portion of said at least one optical fiber; and
a glass wedge secured within said glass tube in proximity to said one end of said ferrule and having an axial surface facing said ferrule, said wedge axial surface being substantially parallel to said one end of said ferrule.

2. The optical fiber collimator recited in claim 1 comprising a plurality of said optical fibers, each having a portion of its respective length within said cylindrical glass ferrule that is bonded to said fibers.

3. The optical fiber collimator recited in claim 1 further comprising a protective material surrounding a remaining portion of said at least one fiber adjacent said ferrule.

4. The optical fiber collimator recited in claim 1 further comprising an anti-reflective optical coating on each of said ferrule axial surface and said wedge axial surface.

5. The optical fiber collimator recited in claim 1 wherein said non-perpendicular angle is in the range of about 75 to 87 degrees.

6. The optical fiber collimator recited in claim 1 wherein said non-perpendicular angle is about 82 degrees.

7. The optical fiber collimator recited in claim 1 further comprising a collimator lens that is axially aligned with and spaced from said wedge by a selected distance.

8. The optical fiber collimator recited in claim 7 wherein said collimator lens is an aspheric lens.

9. The optical fiber collimator recited in claim 7 further comprising an outer protective tube radially surrounding said glass tube and axially longer than said glass tube, said collimator lens being secured within said outer tube beyond said glass tube.

10. The optical fiber collimator recited in claim 7 wherein said selected distance is adjusted for optical performance of said collimator.

11. The optical fiber recited in claim 9 wherein said outer tube has an interior radial surface which is parallel to said glass tube along the entire length of said outer tube.

12. The optical fiber recited in claim 9 wherein said outer tube has an interior radial surface which is parallel to said glass tube along a portion of said outer tube that extends adjacent said glass tube and wherein said outer tube has an interior radial surface which is tapered along a portion of said outer tube which extends beyond said glass tube.

13. The optical fiber collimator recited in claim 12 wherein said collimator lens has a diameter which exceeds the diameter of said glass tube.

14. The optical fiber collimator recited in claim 9 wherein said outer tube is bonded to said glass tube and to said collimator lens.

15. The optical fiber collimator recited in claim 7 wherein said collimator lens comprises anti-reflective optical coatings.

16. An optical fiber collimator for producing substantially collimated beams of light from at least one optical fiber; the collimator comprising:
a cylindrical glass ferrule surrounding at least a terminal portion of said at least one input optical fiber;
a glass tube having an axis and extending radially over said ferrule and being bonded thereto;
a wedge located in said glass tube substantially adjacent said ferrule, said wedge and said ferrule having facing parallel planar axial surfaces that are canted at a non-perpendicular angle relative to said glass tube axis.

17. The optical fiber collimator recited in claim 16 comprising a plurality of said optical fibers, each having a portion of its respective length surrounded by said cylindrical glass ferrule that is bonded to said fibers.

18. The optical fiber collimator recited in claim 16 further comprising a protective material surrounding a remaining portion of said at least one fiber adjacent said ferrule.

19. The optical fiber collimator recited in claim 16 further comprising an anti-reflective optical coating on each of said ferrule axial surface and said wedge axial surface.

20. The optical fiber collimator recited in claim 16 wherein said non-perpendicular angle is in the range of about 75 to 87 degrees.

21. The optical fiber collimator recited in claim 16 wherein said non-perpendicular angle is about 82 degrees.

22. The optical fiber collimator recited in claim 16 further comprising a collimator lens that is axially aligned with and spaced from said wedge by a selected distance.

23. The optical fiber collimator recited in claim 22 wherein said collimator lens is an aspheric lens.

24. The optical fiber collimator recited in claim 22 further comprising an outer protective tube radially surrounding said glass tube and axially longer than said glass tube, said collimator lens being secured within said outer tube beyond said glass tube.

25. The optical fiber collimator recited in claim 22 wherein said selected distance is adjusted for optical performance of said collimator.

26. The optical fiber recited in claim 24 wherein said outer tube has an interior radial surface which is parallel to said glass tube along the entire length of said outer tube.

27. The optical fiber recited in claim 24 wherein said outer tube has an interior radial surface which is parallel to said glass tube along a portion of said outer tube that extends adjacent said glass tube and wherein said outer tube has an interior radial surface which is tapered along a portion of said outer tube which extends beyond said glass tube.

28. The optical fiber collimator recited in claim 27 wherein said collimator lens has a diameter which exceeds the diameter of said glass tube.

29. The optical fiber collimator recited in claim 24 wherein said outer tube is bonded to said glass tube and to said collimator lens.

30. The optical fiber collimator recited in claim 22 wherein said collimator lens comprises anti-reflective optical coatings.
